(19) United States
(12) Patent Application Publication
(10) Pub. No.: US 2008/0126187 A1
(43) Pub. Date: May 29, 2008

(54) Method and System for Determining the Ability of an Organization to Successfully Interact with Government

(76) Inventor: D. Hollis Felkel, Simpsonville, SC (US)

Correspondence Address: DORITY & MANNING, P.A., POST OFFICE BOX 1449, GREENVILLE, SC, 29602-1449, US

(21) Appl. No.: 11/939,204

(22) Filed: Nov. 13, 2007

Related U.S. Application Data
(60) Provisional application No. 60/858,075, filed on Nov. 10, 2006.

(51) Int. Cl. G06F 17/30; G06Q 10/00

(52) U.S. Cl. 705/10; 705/1

(57) ABSTRACT

A novel method and system for analyzing the capability of an organization to effectively advocate on its behalf in the public arena is generally disclosed. The method can help an organization identify existing relationships between members of the organization and participants in government that could be exploited to further the business or goals of the organization, or its industry/sector. The capability of an organization to achieve their goals in the public arena can generally depend on a combination of three factors: (1) existing relationships between members and government participants, (2) the willingness and ability of those members to utilize that relationship in order to advocate on behalf of the organization, and (3) the involvement of the organization in the public arena. The methods and systems evaluate each of the three factors and provide an overall assessment of the capability of an organization to successfully advocate for itself in the public arena.

### PRIORITY INFORMATION

The present application claims priority to U.S. Provisional Patent Application No. 60/858,075 of Hollis Felkel filed on Nov. 10, 2006, the disclosure of which is incorporated by reference herein.

### BACKGROUND OF THE INFORMATION

In the United States, almost every organization interacts in some aspect with some form of government, be it on the local, state, and/or federal levels. The interaction with the government can be in several areas, through laws, regulations, ordinances, etc., which can greatly impact the organization's business and activities. In many instances, the organization may desire to interact with a government entity in an attempt to clarify, change, or suspend a particular law, regulation, ordinance, etc. in order to benefit the organization.

As such, many organizations hire a lobbyist(s) to contact and interact with government participants (e.g., elected officials). However, it may also be beneficial for the organization to have an established personal relationship, through ones of its members, with a participant in the government. A personal relationship may be able to augment the activities of a hired lobbyist. Alternatively, a personal relationship of the organization, through ones of its members, with a participant in the government may negate the need for a hired lobbyist, especially when the organization does not have the means for such a hire. An established personal relationship can facilitate the interaction between the organization and government. Also, an existing personal relationship between a member of the organization and a participant in government can give instant credibility to the member who is advocating on behalf of the organization.

However, members of the organization having an established relationship with a government participant may not always be the leaders or officers (e.g., the decision makers) of the organization. Thus, those decision makers may not know of the existing personal relationship between the member of the organization and the government participant. Also, even if a personal relationship is known to exist between a member of the organization and a government participant, the decision makers may not know if the member is willing to contact that government participant on behalf of the organization.

As such, a need currently exists to determine the existence of existing personal relationships between a member of an organization with a participant of the government. Also, a need exists to evaluate the willingness and ability of that member to use such a relationship to advocate on behalf of the organization.

### DEFINITIONS

As used herein, the term “organization” refers to any entity of at least one person (including both individuals and other entities), such as corporations, companies, partnerships, non-profit organizations and the like.

As used herein, the term “member” refers to any individual associated with the organization, such as an employee, manager, director, officer, owner (shareholder, partner, etc.), board member, and the like.

As used herein, the term “government” is meant to refer to any level of government, such as city, county, state, and/or federal. The term “government” is not limited to those branches having elected officials, but also includes regulatory branches having appointed officials.

As used herein, the term “elected official” refers to an individual elected to office by a voting public on any level, including, but not limited to, city council members, county council members, school board members, sheriffs, state senators, state representatives, state governors, U.S. senators, and U.S. representatives. Also, the term “elected official” includes the President of the U.S., even though the President is elected by the Electoral College.

As used herein, the term “government participant” refers to any individual associated with the government, such as employees, officers, elected officials, appointed officials, their staffs, and the like. An “influential government participant” is an individual that having decision-making abilities or influence on another government participant having such decision-making abilities. For instance, all elected officials are “influential government participants.”

As used herein, the term “existing personal relationship” includes any relationship between the member of the organization and the government participant that existed prior to the time of the survey. While the term “personal relationship” covers all personal relationships (e.g., family, friends, acquaintances, etc.), it is also meant to include professional or working relationships as well.

### DETAILED DESCRIPTION

Reference now will be made to the embodiments of the invention, one or more examples of which are set forth below. Each example is provided by way of an explanation of the invention, not as a limitation of the invention. In fact, it will be apparent to those skilled in the art that various modifications and variations can be made in the invention without departing from the scope or spirit of the invention. For instance, features illustrated or described as one embodiment can be used on another embodiment to yield still a further embodiment. Thus, it is intended that the present invention cover such modifications and variations as come within the scope of the appended claims and their equivalents. It is to be understood by one of ordinary skill in the art that the present discussion is a description of exemplary embodiments only, and is not intended as limiting the broader aspects of the present invention, which broader aspects are embodied exemplary constructions.

The technology discussed herein makes reference to servers, databases, software applications, and other computer-based systems, as well as actions taken and information sent to and from such systems. One of ordinary skill in the art will recognize the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel. When data is obtained or accessed between a first and second computer system or component thereof, the actual data may travel between the systems directly or indirectly. For example, if a first computer accesses a file or data from a second computer, the access may involve one or more intermediary computers, proxies, and the like. The actual file or data may move between the computers, or one computer may provide a pointer or metafile that the second computer uses to access the actual data from a computer other than the first computer, for instance.

The instant disclosure also makes reference to the relay of communicated data over a network such as the Internet. It should be appreciated that such network communications may also occur over alternative networks such as a dial-in network, a local area network (LAN), wide area network (WAN), public switched telephone network (PSTN), the Internet, intranet or Ethernet type networks and others over any combination of hard-wired or wireless communication links.

The various computer systems discussed herein are not limited to any particular hardware architecture or configuration. Any suitable programming, scripting, or other type of language or combinations of languages may be used to implement the teachings contained herein. Embodiments of the methods and systems set forth herein may be implemented by one or more general purpose or customized computing devices accessing software instructions rendered in a computer-readable form. Embodiments of the methods and systems set forth herein may also be implemented by hard-wired logic or other circuitry, including, but not limited to application-specific circuits. Of course, combinations of computer-executed software and hard-wired logic may be suitable, as well.

In general, the present invention is directed to a novel method and system for analyzing the capability of an organization to effectively advocate on its behalf in the public arena. For example, in one embodiment, the present invention is directed to a method of determining the capability of an organization to effectively identify existing relationships between members of the organization and participants in government that could be exploited to further the business or goals of the organization, or its industry/sector.

The present inventor has found that the capability of an organization to achieve their goals in the public arena (e.g., successfully influence influential government participants) can generally depend on a combination of three factors: (1) existing relationships between members of the organization and participants in government, (2) the willingness and ability of those members to utilize that relationship in order to advocate on behalf of the organization, including the attitude of the member towards the political process, and (3) the involvement of the organization or members/stakeholders in the public arena (i.e., the “political capital” of the organization).

Using these factors, the present inventor has developed a method and system to evaluate each of the three factors and to provide an overall assessment of the capability of an organization to successfully advocate for itself in the public arena. In one embodiment, the method and system can generate a report of each relationship between a member of the organization and a government participant. The report can also access the extent of each relationship, as well as the willingness and ability of the member to utilize the relationship to advocate on behalf of the organization. In one particular embodiment, the report can provide a numerical score quantifying the overall capability of the organization to effectively advocate on its behalf in the public arena, as well as each of the three factors identified below. As such, the organization can utilize the report to access those most willing and able to advocate on behalf of the organization on a particular issue to a specific government entity. Also, the report can identify areas of strength of the organization's capabilities, as well as areas that need to be augmented. The organization can track their numerical scores, both overall and for each factor, over time to analyze the progress that the organization has made.

Though the method and system of evaluating the capability of an organization to effectively advocate on its behalf in the public arena can be tailored to each specific organization, depending on a variety of factors, the basic method and system is uniform no matter the organization.

In most embodiments, the first step will be accessing which government entities commonly interact and impact the business and/or goals of the organization. The government entities will generally include those elected officials representing the geographical area(s) (i.e., the voting district) of the organization and any additional government participants that may interact with or impact the organization's business or goals. For example, an organization having all of its offices within the city limits of a town may interact, or wish to interact, with at least one of the elected officials of the town's voting district, including, but not limited to, the City Council, the County Council, the state Senate, the state House of Representatives, the state Governor, the U.S. Senate, the U.S. House of Representatives, and the President of the U.S. In larger companies, more than one voting district may be involved. Also, the organization may not be currently interacting with a particular government entity, but may wish to expand its operation or change its direction, creating the need to interact with a new government entity.

Identification of the goals of the organization can also help narrow the list of government participants with which the organization would wish to interact. Thus, if the goals of the organization would necessitate interaction with a certain government entity, that particular government entity would be targeted for an existing personal relationship between a member of the organization and a participant in that government entity, particularly an influential participant.

Once the government entities with which the organization wishes to interact are identified, those influential participants within those government entities are identified. In one particular embodiment, the elected officials who are part of that government entity, or who oversee that government entity, are identified. For instance, all of the elected officials to the federal government for at least one particular voting district can be identified. Also, all of the elected officials to the state government for at least one voting district can be identified. These identified elected officials are part of the targeted government participants that the organization seeks a personal relationship.

After all of the targeted government participants are identified, each member of the organization is surveyed using an interactive, computerized survey. In one particular embodiment, the survey can be provided by a centralized computer that can be accessed by all of the members of the organization at their own computer. Thus, the survey can be completed by each member of the organization without inconveniencing the members. In fact, in many instances, the survey can be completed in less than 20 minutes.

The survey questions can be tailored to each particular organization, although the basic format of the survey can remain constant. Also, in one particular embodiment, the survey is individually tailored to each member of the organization. For example, the survey can be based upon each member's individual voting district. Thus, the second question in the survey can be the zip code address of the member taking the survey, prompting the user member to enter in his/her home address and/or zip code. The interactive survey can utilize a computer program to take the inputted zip code and determine who the U.S. Senators for that state, the U.S. Representative for that district, and the state senators and representatives for that district. Then, the interactive survey can automatically ask questions directed to any established relationship between those elected officials and the particular member being surveyed. This embodiment is especially useful for organizations having multiple locations, where each member is more apt to live in a different voting district.

Once the targeted government officials are identified for the member taking the survey, the survey begins by asking certain questions. Each question can be generally categorized as addressing one of the three factors above, specifically, (1) relationships, (2) attitude and general ability to serve as an effective advocate, and (3) the “political capital” of the organization or individual.

In one embodiment, the survey can begin with general questions related to the general attitude of the member with respect to the political process. For instance, the questions can be tailored to determine the level of interest that the member has in the political process and political issues. Also, the questions can determine the level of importance that the person places on the political process, both in day-to-day life and the organization's activities. In one embodiment, the survey can ask the extent of any involvement of the member in the political process. For instance, the question can have a series of activities that the member can indicate he/she has participated in, including, but not limited to,

A. Attended a public meeting of city or county council

B. Contacted an elected official at any level

C. Served on a committee or board for a local organization

D. Contacted a newspaper or radio show with an opinion

E. Been actively involved in a group trying to influence public policy

F. Made a speech on a political or community issue

G. Attended a political rally, speech, protest or other event

H. Worked for a political party

I. Held or run for public office

In some embodiments, the member can be specifically asked if he/she has ever worked on a political campaign at any level, either as a volunteer or paid staffer, or has ever contributed money to a political campaign. However, care must be taken to avoid asking questions directed to that members political beliefs. As such, the survey does not ask for the voting records of the member, any membership in a political party, or any other information that could reveal the personal political beliefs of the member. The aim of these attitude questions is directed to the attitude about the members involvement in the political process, not the personal political beliefs of the member.

The attitude questions can also be directed to the attitude of the member regarding the involvement of the organization in the political arena. For example, the survey can ask the member belief of the extent that political involvement is important to the organization's success. Also, the survey can ask whether the member feels it is appropriate for the organization to comment on which candidates are deserving of your vote or financial support. Additionally, the survey can ask if that member has ever made a suggestion or recommendation to the organization relating to making a political contribution, supporting legislation, or any other political activity. For instance, the member can be asked their recommended course of action if one of the major issues in an upcoming election would greatly affect the organization.

The attitude questions can also help gauge the willingness of that person to utilize an existing personal relationship with an elected official. For example, the survey can ask if such a personal relationship exists, how appropriate is it for that person to approach the elected official concerning a public policy issue.

The survey can also ask about the advocability by the organization in the past, and the member's receptiveness to any such advocability by the organization. For example, the survey can ask if the member has ever been notified or asked by the organization to participate in a political activity or to contact an elected official on behalf of the organization. If this answer is yes, the survey can ask if the member decided to participate in that activity. Also, the survey can ask if the member is asked in the future to participate in a political activity or to contact an elected official on behalf of the organization, would he/she be willing to participate.

The political capital of the organization can be determined, as viewed by the member taking the survey. For example, the survey can ask how the member believes that the organization is viewed when it comes to effectively handling political issues and/or affecting public policy, compared to similar organizations. Also, the survey can gage the member's view of how well the organization educates and engages members in political issues that impact the organization.

The survey can also identify any existing personal relationship between the member and an influential government participant, such as an elected official or a staff member of the elected official. Questions can be asked that specifically ask if the member has any relationship with the targeted elected officials, such as those state and federal elected officials from the member's voting district. Also, an open ended question can be asked to determine the existence of a personal relationship to a government participant outside of the member's voting district. After the existence of any relationship between each of those target government participants and that member is determined, the survey asks how that person would contact that particular government participant with whom there exists a personal relationship in order to discuss an issue of importance to the organization. The type of contact that person would utilize can further identify the extent of the personal relationship between the member and the government participant.

### EXAMPLE 1

The following is an exemplary interactive survey that can be used in the methods and system described herein. In this print-out, each question is followed by an input means for answering the question. For example, a drop-down answer box follows each question where only one answer is requested. Alternatively, when multiple answers can be given, a selection box can be placed next to each possible answer.

### Disclaimer

The following survey is being conducted on behalf of our organization for the purpose of determining our strengths and weaknesses as relates to public policy and political involvement. The questions deal with your perceptions on public policy and your relationship with certain elected officials. Your open and honest answers will be used to assist our public affairs efforts and will have no affect on your standing with our organization. While your participation will be highly valuable and greatly appreciated, it is not mandatory. If you choose not to take the survey please exit now otherwise select continue.
1. What is your home address and zip code at your primary residence?
2. How often would you say that you read articles about political issues and topics whether online, in a newspaper or in a magazine?
   Please Select One:
   Multiple times a day
   Daily
   Few times a week
   Occasionally
   Rarely
   Never
3. How important do you believe political involvement is to our organization's overall success?
   Please Select One:
   Very Important
   Important
   Unimportant
   Very Unimportant
4. How comfortable would you be representing our organization on public policy issues? For example, would you be comfortable signing an op-ed to be placed in papers across the state, sending a letter to an elected official or speaking on the topic?
   Please Select One:
   Very comfortable
   Comfortable
   Uncomfortable
   Very uncomfortable
   Unsure
5. How appropriate do you feel it is for our organization to comment on which candidates deserve your vote or financial support?
   Please Select One:
   Very Appropriate
   Appropriate
   Inappropriate
   Very Inappropriate
   No Opinion
6. Have you ever been notified about or asked by our organization to participate in a political activity such as a political forum or to contact an elected official on our behalf?
   Please Select One:
   Yes
   No
7. (Only asked if the answer to number 6 is “Yes”) Did you decide to participate?
   Please Select One:
   Yes
   No
   No, but I might have under different circumstances
8. If asked, would you participate in the future?
   Please Select One:
   Yes
   No
   It would depend on the situation
9. Have you ever made a suggestion/recommendation to our organization relating to making a political contribution, supporting legislation or any other political activity?
   Please Select One:
   Yes
   No
10. Compared to similar organizations across the state and region, how do you believe we are viewed when it comes to our effectiveness in handling political issues and/or affecting public policy?
   Please Select One:
   Much Better
   Better
   Same as
   Worse
   Much Worse
   Don't Know
11. If in an upcoming election one of the major debates is over an issue that will greatly affect our organization. What would you recommend as our best course of action?
   Please Select One:
   Actively encourage member voting
   Financially contribute to a candidate
   Avoid any campaign involvement
   Publicly endorse one of the candidates
   Privately support a candidate
12. If someone has a personal or professional relationship with an elected official who could potentially assist their organization on public policy issues, how appropriate would it be for them to request their assistance?
   Please Select One:
   Very Appropriate
   Appropriate
   Inappropriate
   Very Inappropriate
   Depends on the situation
13. Please select any of the following which you have done in the past year . . .
   Attended a public meeting of city or county council
   Contacted an elected official at any level
   Served on a committee or board for a local organization
   Contacted a newspaper or radio show with an opinion
   Been actively involved in a group trying to influence public policy
   Made a speech on a political or community issue
   Attended a political rally, speech, protest or other event
   Worked for a political party
   Held or run for public office
14. Have you ever worked on a political campaign at any level either as a volunteer or paid staffer?
   Please Select One:
   Yes, as a staffer
   Yes, as a volunteer
   No
15. How would you rate our organization when it comes to educating and engaging members in the political process?
   Please Select One:
   Very Effective
   Effective
   Neutral
   Ineffective
   Very Ineffective
16. Have you ever given money to a political campaign?
   Please Select One:
   Yes, I am a frequent donor
   Yes, I have contributed in the past
   No, I have never contributed but would consider it
   No, I have never and will never contribute
   I choose not to answer
17. Thinking back on your entire professional career, have you ever worked for a government official or agency? This could even have been serving as an intern in high school or college.
   Please Select One:
   Yes
   No
18. Please rate the level of your relationship with State Representative [Name of State Representative associated with Zip Code from question 1].
   Please Select One:
   Excellent Personal
   Excellent Staff
   Good Personal
   Good Staff
   Fair Personal
   Fair Staff
   Poor
   No Relationship
19. Please rate the level of your relationship with State Senator [Name of State Senator associated with Zip Code from question 1].
   Please Select One:
   Excellent Personal
   Excellent Staff
   Good Personal
   Good Staff
   Fair Personal
   Fair Staff
   Poor
   No Relationship
20. Please rate the level of your relationship with State Governor [Name of State Governor associated with Zip Code from question 1].
   Please Select One:
   Excellent Personal
   Excellent Staff
   Good Personal
   Good Staff
   Fair Personal
   Fair Staff
   Poor
   No Relationship
21. Please rate the level of your relationship with United States Representative [Name of U.S. Representative associated with Zip Code from question 1].
   Please Select One:
   Excellent Personal
   Excellent Staff
   Good Personal
   Good Staff
   Fair Personal
   Fair Staff
   Poor
   No Relationship
22. Please rate the level of your relationship with United States Senator [Name of U.S. Senator associated with Zip Code from question 1].
   Please Select One:
   Excellent Personal
   Excellent Staff
   Good Personal
   Good Staff
   Fair Personal
   Fair Staff
   Poor
   No Relationship
23. Please rate the level of your relationship with United States Senator [Name of 2^{nd} U.S. Senator associated with Zip Code from question 1].
   Please Select One:
   Excellent Personal
   Excellent Staff
   Good Personal
   Good Staff
   Fair Personal
   Fair Staff
   Poor
   No Relationship
24. (If the answer to any of questions 18-22 is Excellent or Good, either Personal or Staff, then the following question is asked for that particular elected official. This question is repeated for each elected official identified as having a good or excellent relationship.) How would you be most likely to contact [elected official's position] [elected official's name] to discuss an issue of importance to our organization?.
   Please Select One:
   Letter
   Email
   Discuss in person at unrelated event
   Face to Face Meeting
   Contact the Staff
   Phone Call
   I would not be comfortable contacting
25. Are you registered to vote?
   Please Select One:
   Yes
   No

### EXAMPLE 2

The following is a sample report generated by an exemplary trial of the survey with respect to a fictitious organization, XYZ, Corp.

These and other modifications and variations to the present invention may be practiced by those of ordinary skill in the art, without departing from the spirit and scope of the present invention, which is more particularly set forth in the appended claims. In addition, it should be understood the aspects of the various embodiments may be interchanged both in whole or in part.

1. A method for determining the existence of any personal relationships between a member of an organization and a government participant, the method comprising:
determining which voting district in which the member of the organization resides;
identifying a personal relationship between the member of the organization and a government participant;
evaluating the strength of the identified personal relationship between the member of the organization and the government participant; and
evaluating the ability and willingness of the member of the organization to use the identified personal relationship to contact the government participant on behalf of the organization.

2. A method as in claim 1, wherein the government participant is an elected official elected by voters from the voting district in which the member of the organization resides.

3. A method as in claim 1 further comprising
identifying each elected official representing the voting district in which the member resides; and
determining the existence of any relationship between the member and each elected official representing the voting district in which the member resides.

4. A method of surveying all members of an organization to determine which member can act on behalf of the organization, the method comprising:
repeating the method of claim 1 with respect to every member of the organization to determine the existence of any personal relationships between each member of the organization and a government participant; and
reporting the existence of any identified personal relationships between each member of the organization and a government participant.

5. A method as in claim 4 further comprising
reporting the willingness of each member to contact a government participant on behalf of the organization.

6. A method as in claim 5 further comprising generating a report of each identified relationship between each member of the organization and a government participant, wherein a numerical score is assigned to each member of the organization to compare their ability and willingness to contact a government participant on behalf of the organization.

7. A method as in claim 1, wherein evaluating the ability and willingness of the member of the organization to use the identified personal relationship to contact the government participant on behalf of the organization comprises asking how the member of the organization would contact the government participant on behalf of the organization.

8. A method as in claim 1, wherein evaluating the ability and willingness of the member of the organization to use the identified personal relationship to contact the government participant on behalf of the organization comprises asking if the member has ever given money to any political campaign.

9. A system for determining the existence of any personal relationships between a member of an organization and a government participant, the system comprising at least one computing device configured to determine which voting district in which the member of the organization resides; identify a personal relationship between the member of the organization and a government participant; evaluate the strength of the identified personal relationship between the member of the organization and the government participant; and evaluate the ability and willingness of the member of the organization to use the identified personal relationship to contact the government participant on behalf of the organization.

10. A system as in claim 9, wherein the computing device is further configured to associate the elected officials representing the voting district in which the member of the organization resides, and then determine the existence of any relationship between the member and each elected official representing the voting district in which the member resides.

11. A system as in claim 9, wherein the computing device generates a report evaluating the willingness of each member to contact a government participant on behalf of the organization.

12. A system as in claim 9, wherein the computing device generates a report of each identified relationship between each member of the organization and a government participant, wherein a numerical score is assigned to each member of the organization to compare their ability and willingness to contact a government participant on behalf of the organization.

13. A system as in claim 9, wherein the computing device asks each member how the member of the organization would contact the government participant on behalf of the organization.

14. A system as in claim 9, wherein the computing device asks each member if the member has ever given money to any political campaign.

15. A system as in claim 9, wherein the computing device evaluates input from the member concerning the existence of an existing relationship with a government participant and interactively generates a series of questions to evaluate the strength of such an existing relationship.

16. A system as in claim 15, wherein the computing device evaluates input from the member concerning the existence of an existing relationship with a government participant and interactively generates a series of questions to evaluate the willingness of the member to exploit such an existing relationship to advocate on behalf of the organization.
